(19) United States
(12) Patent Application Publication
(10) Pub. No.: US 2023/0252612 A1
(43) Pub. Date: Aug. 10, 2023

(54) DE-GHOSTING AND SEE-THROUGH PREVENTION FOR IMAGE FUSION

(71) Applicant: INNOPEAK TECHNOLOGY, INC., Palo Alto, CA (US)

(72) Inventors: Kim Chai Ng, Palo Alto, CA (US); Jinglin Shen, Palo Alto, CA (US); Chiu Man Ho, Palo Alto, CA (US)

(21) Appl. No.: 18/131,216

(22) Filed: Apr. 5, 2023

Related U.S. Application Data
(63) Continuation of application No. PCT/US2021/031521, filed on May 10, 2021.
(60) Provisional application No. 63/113,151, filed on Nov. 12, 2020.

(51) Int. Cl. G06T 5/50; G06T 5/30; G06T 7/194; G06T 7/30; G06V 10/25

(52) U.S. Cl. CPC G06T 5/50; G06T 5/30; G06T 7/30; G06T 7/194; G06V 10/25; G06T 2207/10024; G06T 2207/10028; G06T 2207/20132; G06T 2207/20221; G06T 2207/20228

(57) ABSTRACT

In some embodiments, an image processing application receives a first image and a second image for fusing. The image processing application generates a foreground object mask for a foreground object in the first image and dilates the foreground object mask to generate a dilated mask. The image processing application further integrates the image content of the first image in at least the dilated mask with the second image to generate an updated second image. The image processing application fuses the first image and the updated second image to generate a fused image

### CROSS-REFERENCE TO RELATED APPLICATIONS

This application is a continuation of International Application No. PCT/US2021/031521, filed on May 10, 2021, which claims priority to U.S. Provisional Application No. 63/113,151, entitled “Color Image & Near-Infrared Image Fusion with Base-Detail Decomposition and Flexible Color and Details Adjustment,” filed on Nov. 12, 2020. The disclosures of the aforementioned applications are hereby incorporated by reference in their entireties.

### FIELD

This disclosure relates generally to computer-implemented methods and systems for computer image processing. Specifically, the present disclosure involves de-ghosting and see-through prevention for image fusion.

### BACKGROUND

Image fusion is a process of combining the information from different sources of images into one compact form of an image. For example, a color image and a near-infrared (NIR) image can be fused to increase details of the color image due to extra information provided by the NIR image while preserving the color and brightness of the color image. However, when fusing multiple images, there may be ghosting artifacts in the combined image where multiple instances of the same object (i.e., ghosts) appear in the fused image. The ghosting artifacts are caused by, for example, a typical image misalignment associated with multi-image registration. In addition, if an NIR image is used for fusing with another image, a see-through problem may arise. That is, certain objects (such as a piece of clothing) may appear to be transparent in the combined image. This may be due to the physical characteristics of the NIR wavelength (650 nm~1100 nm) that can penetrate the object. For example, some material opaque to human eyes may appear transparent in the NIR wavelength, such as clothing, and plastic, etc. Existing image fusion techniques have not been considered and thus do not prevent the see-through problems in the fused images. In addition, de-ghosting techniques used in the existing image fusion cannot completely remove the ghosting artifacts, leading to the low visual quality of fused images.

### SUMMARY

Certain embodiments involve de-ghosting and see-through prevention for image fusion. In one example, a computer-implemented method includes receiving a first image and a second image; generating a foreground object mask for a foreground object in the first image; dilating the foreground object mask to obtain a dilated mask; integrating image content extracted from the first image according to the dilated mask with the second image to obtain an updated second image; and fusing the first image and the updated second image to obtain a fused image.

In another example, a non-transitory computer-readable medium having program code that is stored thereon, the program code executable by one or more processing devices for performing operations. The operations include generating a foreground object mask for a foreground object in a first image; dilating the foreground object mask to obtain a dilated mask; integrating image content extracted from the first image according to the dilated mask with a second image to obtain an updated second image; and fusing the first image and the updated second image to obtain a fused image.

In yet another example, a system includes a processing device; and a non-transitory computer-readable medium communicatively coupled to the processing device. The processing device is configured to execute program code stored in the non-transitory computer-readable medium and thereby perform operations. The operations include generating a foreground object mask for a foreground object in a first image; dilating the foreground object mask to obtain a dilated mask; and integrating image content extracted from the first image according to the dilated mask with a second image to obtain an updated second image.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment for de-ghosting and see-through prevention for image fusion, according to some embodiments of the present disclosure.

FIG. 2 depicts an example of a process for fusing images with de-ghosting and see-through prevention, according to some embodiments of the present disclosure.

FIG. 3 depicts an example of an input image, an object mask for an object in the input image, and the cropped portion from the input image based on the object mark, according to some embodiments of the present disclosure.

FIG. 4 depicts an example of an NIR image, and an updated NIR image by integrating the cropped portion of the input image shown in FIG. 3 into the NIR image, according to some embodiments of the present disclosure.

FIG. 5 depicts an example of a fused image of the input image shown in FIG. 3 and the NIR image shown in FIG. 4 according to some embodiments of the present disclosure and a fused image using prior art technology.

FIG. 6 depicts an example of a computing system that can be used to implement some embodiments of the present disclosure.

### DETAILED DESCRIPTION

Various embodiments can provide de-ghosting and see-through prevention techniques for image fusion. As discussed above, existing image fusion methods may generate unsatisfactory results containing ghosting artifacts and see-through problems. Various embodiments described herein address these problems by modifying an input image (e.g., an NIR image) with content from another input image (e.g., an RGB color image) prior to fusing the two images. In one embodiment, an image processing application detects a foreground object in a first input image (e.g., the RGB image). In that embodiment, the image processing application extracts the image content of the first image containing the detected foreground object and inserts the extracted image content into a second image (e.g., the NIR image) to generate an updated second image. In this way, the image processing application fuses the first image and second images by updating the second image with contents from the first image before fusing the two images.

The following non-limiting example is provided to introduce some embodiments. In this example, an image processing application can receive a first image and a second image for fusing and generating a fused image from these two images. For instance, the first image and the second image can both be digital photographs. The first image may be an RGB color image of a real-world scene captured by a regular color camera and the second image may be an NIR image of the real-world scene captured by an NIR camera. The two images may have an overlapping field of view of the real-world scene. In one embodiment, the two images may be captured simultaneously or near simultaneously by image sensors mounted in proximity on a device. For example, the device may be a smartphone equipped with a first image sensor capable of capturing a color image and a second image sensor capable of capturing a NIR image. However, this is merely illustrative, and thus not intended to be limiting. It is contemplated that a single image sensor may be capable of capturing a color image and a NIR image of a scene at the same time.

Referring back to the non-limiting example, the image processing application can detect a foreground object in the first image, such as a human object or another type of object. Because the two images have an overlapping field of view of the same real-world scene, one or more foreground objects captured in the first image may also be captured in the second image. In that example, the image processing application can be configured to further generate an object mask for the foreground object and to dilate the object mask. Ghosting artifacts typically occur near the edges of objects, especially the foreground objects in the images. For NIR images, the see-through problems are most visible on the foreground objects and the severity decreases as the distance of the object from the camera increases. As such, detecting foreground objects and generating object masks for these foreground objects can locate the regions where the problems occur. Further dilating the object mask allows these regions to expand to the surrounding areas. As discussed below, this expansion leads to the reduction or elimination of the ghosting artifacts.

In some embodiments, one or more structuring elements used in dilation can be determined according to a disparity of the foreground object between the two images. The image processing application can be configured to extract or crop image content according to the dilated mask from the first image. An updated second image can be generated by integrating the extracted or cropped image content into the second image. The integration may be performed by replacing the corresponding content in the second image with the extracted content from the first image through, for example, Poisson blending. Because the dilated object mask of a foreground object allows the surrounding area of the foreground object in the first image to be extracted, the extracted image content is large enough to replace the entire foreground object in the second image. As a result, in the updated second image, the content of the foreground object is obtained from the first image at the same location, the foreground object in the updated second image and the corresponding foreground object in the first image are aligned. Therefore, the ghosting artifacts near the foreground object when fusing the first image and the updated second image can be reduced or eliminated. In addition, if the corresponding foreground object in the second image has a see-through region, the see-through region is removed from the updated second image, thereby eliminating the see-through problem in the fused image. The image processing application can then generate the fused image by fusing the first image and the updated second image. In various embodiments, this process may also be applied to scenarios where there are multiple foreground objects.

As described herein, some embodiments provide improvements in image fusion by reducing ghosting artifacts in the fused image and at the same time preventing the aforementioned see-through problems. The regions where the ghosting artifacts and/or the see-through problems occur most often are detected through detecting foreground objects. By replacing the region in the second image containing the foreground objects with the corresponding region from the first image, the foreground objects in the first image and the updated second image are aligned and thus the ghosting artifacts can be eliminated. In addition, the replacing also removes the see-through region on the foreground object from the updated second image. As a result, fusing the first image and the updated second image would not have the see-through problems. Image fusing techniques in accordance with the present disclosure can be used for dehazing images and high dynamic range imaging (HDR). These added capabilities of image enhancement can then be used in applications such as autonomous driving and visual surveillance.

### Example Operating Environment for Foreground Aware Image Inpainting

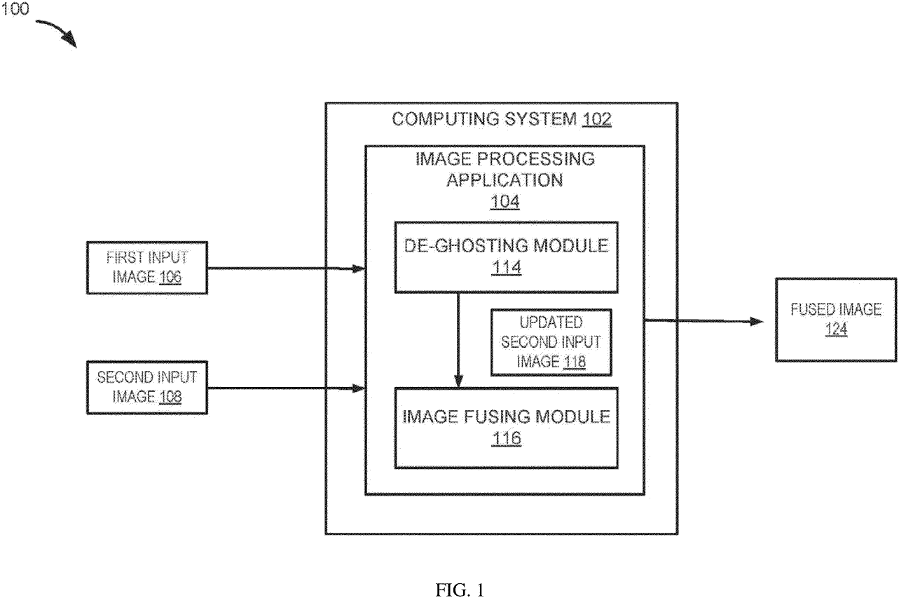

Referring now to the drawings, FIG. 1 depicts an example computing environment 100 for de-ghosting and see-through prevention for image fusion, according to some embodiments of the present disclosure. As shown, the computing environment 100 includes a computing system 102, which can include a processing device executing an image processing application 104 to perform image fusion with de-ghosting and see-through prevention. The processing device may be a smartphone, a tablet, a personal computer (“PC”), a desktop workstation, a laptop, a notebook, a server computer, a set-top box, a robot, an unmanned vehicle or any other computing device capable of executing the image processing application 104.

The image processing application 104 can receive multiple input images for fusing. For instance, as shown in FIG. 1, the image processing application 104 may receive a first input image 106 and a second input image 108. In some examples, the image processing application 104 may receive the first input image 106 and the second input image 108 directly from cameras capturing the respective input images (not shown in FIG. 1). For example, the first input image 106 may be a red-green-blue (RGB) color image captured by a regular color camera and the second input image 108 may be an NIR image captured by an NIR camera. In this example, the first input image 106 and the second input image 108 can be received from the regular color camera and the NIR camera, respectively, by the image processing application 104. The cameras may be cameras integrated with the processing device of the computing system 102 (e.g., cameras on a smartphone processing device).

In other examples, the image processing application 104 can receive the first input image 106 and the second input image 108 by accessing a storage device of the computing system 102 configured for storing the images. Alternatively, or additionally, the image processing application 104 may receive the first input image 106 and the second input image 108 over a network connected to by the computing system 102. The image processing application 104 may receive the first input image 106 and the second input image 108 in other ways.

To fuse the first input image 106 and the second input image 108, in example implementations, as shown in this example, the image processing application 104 can employ a de-ghosting module 114 to prepare the first input image 106 and the second input image 108 for fusion and an image fusing module 116 to fuse the first input image 106 and the second input image 108 prepared by the de-ghosting module 114. The output of the image fusing module 116 is a fused image 124.

In some examples, the de-ghosting module 114 can be configured to detect foreground objects in the first input image 106. Because ghosting artifacts, and see-through issues if there are any, mostly occur around the foreground objects, detecting the foreground objects allows the image processing application 104 to focus on the relevant regions of the first input image 106. For example, a foreground object can be detected by inferring depths on the scene. Depth estimation algorithms using images and 3D sensors can be used to determine the depths. Based on the depth information, the foreground objects can be determined to be the objects closer to the camera and also not exceed a defined, threshold distance from the camera. Alternatively, or additionally, for see-through prevention, human object detection can be accomplished using deep learning techniques. In further examples, traditional image segmentation algorithms, such as Watershed and GrabCut, can also be used to separate out the foreground objections from background objects.

For each of the detected foreground objects, the image processing application 104 can generate an object mask, such as a binary image indicating the location of the pixels of the foreground object within the first input image 106. The image processing application 104 can dilate the object mask so that the object mask also covers the surrounding region of the foreground object. Based on the dilated object mask, the image processing application 104 can extract the image content, from the first input image 106, which contains the foreground object and its surrounding region. The extracted image content can then be combined or integrated with the second input image 108 to generate an updated second input image 118. Ghosting artifacts typically occur near the edges of objects, especially the foreground objects in the images. For NIR images, the see-through problems are most visible on the foreground objects and the severity decreases as the distance of the object from the camera increases. As such, detecting foreground objects and generating object masks for these foreground objects can help to locate the regions where the problems occur. Further dilating the object mask allows these regions to expand to the surrounding areas. As discussed below, this expansion leads to the reduction or elimination of the ghosting artifacts.

In some implementations, the combination or integration of the extracted image content and the second input image 108 is performed by replacing the corresponding content (e.g., co-located content) in the second input image 108 with the extracted image content from the first input image 106, for example, through Poisson blending. In some examples, the corresponding content in the second input image is co-location content that is located at the same position in the second input image as the extracted image content located in the first input image. In other words, each pixel in the extracted image content is used to replace a pixel in the second input image having the same coordinate as the pixel in the first input image. For example, if a pixel in the extracted image content has coordinates (a, b) in the first input image, that pixel is used to replace the pixel located at (a, b) in the second input image.

The output of the combination or integration of the extracted image content and the second input image 108is the updated second input image 118. Because the dilated object mask of a foreground object allows the surrounding area of the foreground object in the first input image 106 to be extracted, the extracted image content is large enough to replace the entire foreground object in the second input image 108. As a result, in the updated second input image 118, the content of the foreground object is obtained from the first input image 106 at the same location, the foreground object in the updated second input image 118 and the corresponding foreground object in the first input image 106 are aligned. Therefore, the ghosting artifacts near the foreground object when fusing the first input image 106 and the updated second input image 118 can be reduced or eliminated. In addition, if the corresponding foreground object in the second input image 108 has a see-through region, the see-through region is removed from the updated second input image 118, thereby eliminating the see-through problem in the fused image 124.

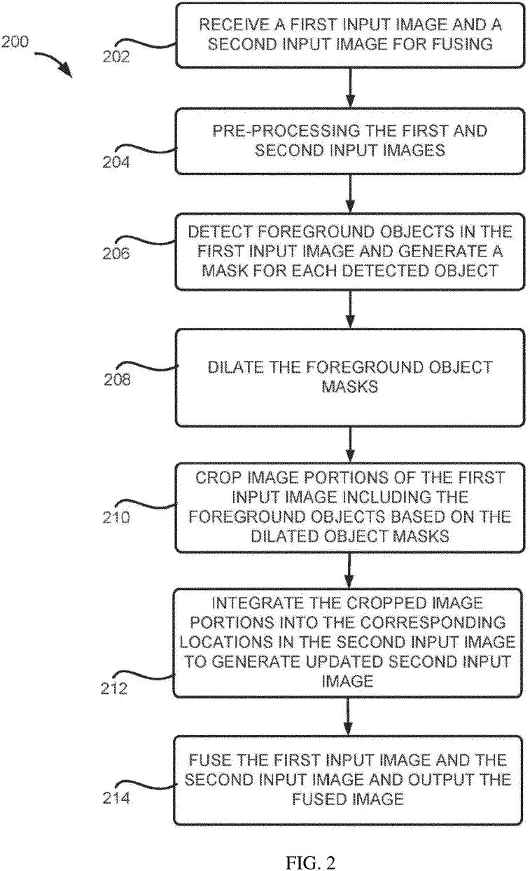

The same process can be applied to other foreground objects to eliminate the ghosting artifacts, and see-through regions if there are any, around other foreground object regions. The image processing application 104 can further employ the image fusing module 116 to fuse the first input image 106 with the updated second input image 118 to generate and output the fused image 124. Additional details regarding de-ghosting and see-through prevention for image fusion are described herein with respect to FIGS. 2-5.

### Examples of Computer-Implemented Operations for Image Fusion With De-Ghosting and See-Through Prevention

FIG. 2 depicts an example of a process 200 for fusing two images with de-ghosting and see-through prevention, according to some embodiments of the present disclosure. One or more computing devices (e.g., the processing devices in the computing system 102) implement operations depicted in FIG. 2 by executing suitable program code (e.g., the image processing application 104). For illustrative purposes, the process 200 is described with reference to certain examples depicted in the figures. Other implementations, however, are possible.

At block 202, the process 200 involves receiving a first input image 106 and a second input image 108 for image fusion. For instance, the image processing application 104 can receive the first input image 106 and the second input image 108 directly from cameras capturing the respective input images. In the example where the first input image 106 is an RGB color image captured by a regular color camera and the second input image 108 is an NIR image captured by a NIR camera, the image processing application 104 can receive the first input image 106 and the second input image 108 from the respective cameras. In other examples, the image processing application 104 can receive the first input image 106 and the second input image 108 by a user operating in a user interface presented by the image processing application 104 to select or otherwise specify the first input image 106 and the second input image 108. The image processing application 104 might also receive the first input image 106 and the second input image 108 from another module of the image processing application 104 or another application executing on the computing system 102 or another computing system. The first input image 106 and the second input image 108 might be stored locally on the computing system 102 or sent to the image processing application 104 via a network.

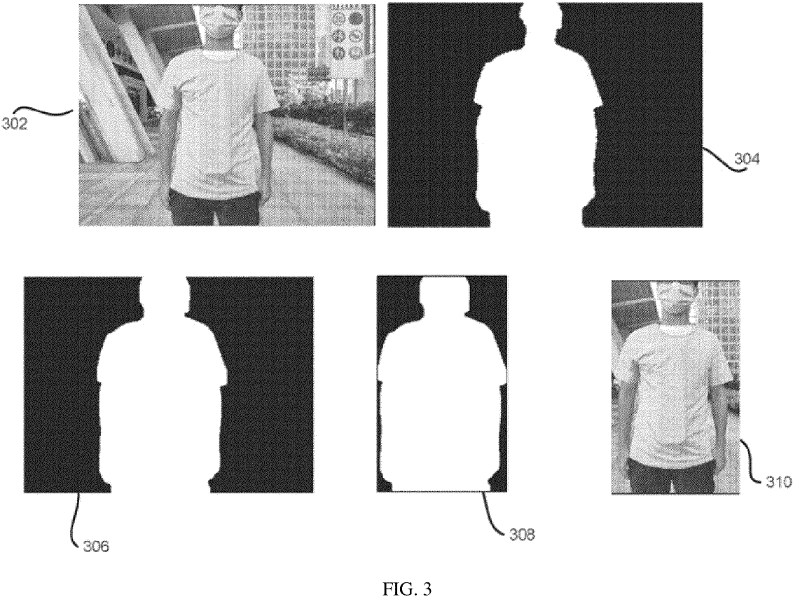

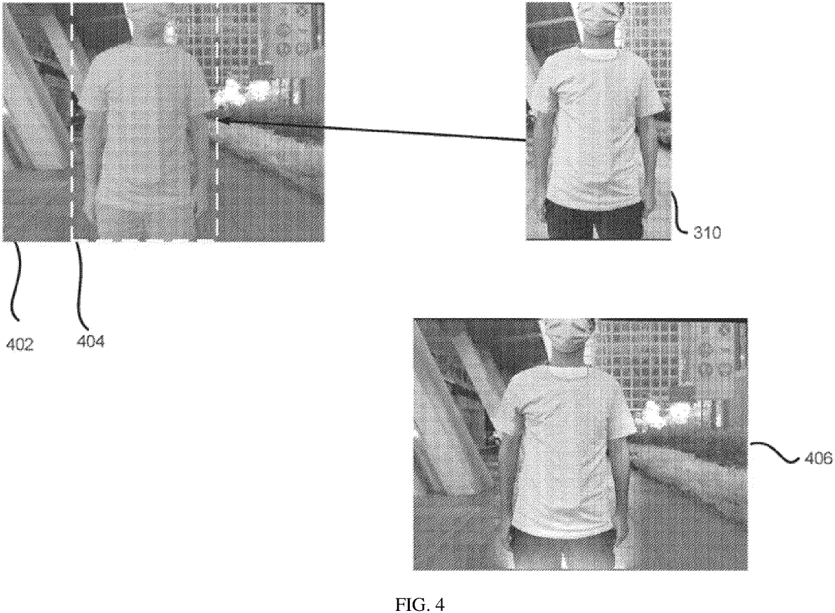

In some examples, the first image 106 and the second image 108 are both digital photographs and have an overlapping field of view of a real-world scene. FIG. 3 shows an example of an input image 302 and FIG. 4 shows an example of an NIR image 402. The input image 302 and the NIR image 402 are respectively captured by a regular camera and an NIR camera pointing to the same real-world scene. The two images have an overlapping field of view of the scene where both depict a man standing in front of the camera with a road, buildings, and sky in the background. In addition, the NIR image 402 shows the text of the plate under the clothes of the human object in the image.

Referring back to FIG. 2, at block 204, the process 200 involves pre-processing the first input image 106 and the second input image 108. One or more computing devices execute program code from the image processing application 104 to implement block 204. For instance, if the first input image 106 and second input image 108 are not aligned, the image processing application 104 can perform image registration to transform the first input image 106 and the second input image 108 into one coordinate system, thereby align the two images. The image processing application 104 can perform the image registration using intensity-based image registration, feature-based image registration, or a combination of both.

In another example, the image processing application 104 can determine the disparities of the corresponding pixels in the first input image 106 and the second input image 108. The disparity is the distance between a pair of corresponding pixels in two images when the two images are superimposed. Different pairs of pixels may have different disparities. For a pair of images that are captured by two cameras from a similar point of view, the disparities of pixels on a foreground object are larger than that of pixels in the background. In some implementations, the image processing application 104 is configured to calculate the largest disparity of pixels on a foreground object (also referred to as the largest disparity of a foreground object, for brevity) between the first input image 106 and the second input image 108.

To determine the largest disparity of an object, the image processing application 104 can find the disparities of pixels on the object between the first input image 106 and the second input image 108. For a pixel on an object in the first input image 106 (e.g., a feature point of the object), the image processing application 104 can identify the corresponding pixel (e.g., the corresponding feature point) on the corresponding object in the second input image 108. The coordinate difference between these two pixels can be determined as the disparity of the pixel. The image processing application 104 can sample multiple pixels on the object and determine the respective disparities. The largest disparity among these disparities can be determined as the largest disparity of the object. Other methods can also be used to determine the disparity of an object in the first input image 106 and the second input image 108.

At block 206, the process 200 involves detecting foreground objects in the first input image 106 and generate object masks for the foreground objects. In some examples, the image processing application 104 can detect the foreground objects by obtaining depth information of the scene captured in the image, by using depth estimation algorithms based on images and 3D sensors. The foreground objects can be determined to be the objects closer to the camera and also not exceed a defined, threshold distance from the camera. Alternatively, or additionally, for see-through prevention, human object detection can be accomplished using deep learning techniques. In further examples, traditional image segmentation algorithms, such as Watershed and GrabCut, can also be used to separate out the foreground objections from background objects. For each of the detected foreground objects, the image processing application 104 generates an object mask such as a binary image indicating the location of the pixels of the foreground object within the first input image 106. FIG. 3 shows an example of the generated object mask 304 for the human object detected from the input image 302.

At block 208, the process 200 involves dilating the foreground object masks. The image processing application 104 can dilate an object mask using a structuring element having a size N-by-N. In some examples, the size N of the structuring element is determined based on the disparities of the foreground object. For instance, the image processing application 104 can determine N to be the largest disparity of the most forefront object between the first input image 106 and the second input image 108. The most forefront object can be determined based on, for example, the depth information of the images. The object among the detected foreground objects that is closest to the camera will be determined as the most forefront object. In another example, the image processing application 104 can determine the N to be the largest disparity of foreground object currently being processed. In further examples, the image processing application 104 can add an adjustment parameter n to the value of N determined above, where n is a non-negative integer. A higher value of n allows the ghosting artifacts to be eliminated more completely but it also leads to more information being removed from the second input image 108; a lower value of n preserves more information from the second input image 108, but may lead to some residual ghosting artifacts or other artifacts introduced when generating the updated second input image 118. The image processing application 104 can determine the value of n based on the relative importance of de-ghosting and preserving information from the second input image 108. FIG. 3 shows a dilated object mask 306 by dilating the object mask 304.

At block 210, the image processing application 104 can crop or extract, from the first input image 106, the image portions containing the foreground objects and their respective surroundings. In some examples, the image processing application 104 can extract the image portion for a foreground object by generating a bounding box of the dilated mask. The image processing application 104 can further crop the image portion of the first input image 106 that falls in the bounding box. FIG. 3 shows an example of the cropped portion of the dilated object mask 306 with a bounding box 308. The cropped image 310 is extracted from image 302 using the bounding box 308. As can be seen from this example, the cropped image 310 contains the human foreground object and the surrounding region. If the first input image 106 contains multiple foreground objects, the image processing application 104 can use the same process to extract relevant portions from the first input image 106. It should be understood that the example shown in FIG. 3 is for illustration purposes only and should not be construed as limiting. The image processing application 104 can extract the image portions from the first input image 106 using methods that do not involve a bounding box.

Referring back to FIG. 2, at block 212, the process 200 involves integrating the cropped image portions into the corresponding locations in the second input image 108 to generate an updated second input image 118. The image processing application 104 can replace the content in the second input image 108 with the corresponding extracted image content from the first input image 106. To reduce the artifacts introduced by the replacement, the image processing application 104 can further adjust the color, intensity, or other aspects of the second input image 108. In some examples, Poisson blending is employed to integrate the cropped image portions into the corresponding locations in the second input image 108. The output of this integration is an updated second input image 118. FIG. 4 shows an example of the updated second input image 406. The updated second input image 406 is generated by inserting the cropped image 310 that is extracted from the input image 302 into the second image 402 using Poisson blending. The rectangle 404 indicates the region in the second image 402 where the cropped image 310 is inserted. As can be seen from image 406, the intensity of the cropped image 310 have been adjusted during the integration to avoid visible artifacts in the resulted image 406. In the updated image 406, the text of the plate under the clothes of the human object is invisible.

At block 212, the process 200 involves fusing the first input image 106 and the updated second input image 118 to generate the fused image 124. The image processing application 104 can fuse the two images using any image fusion method. For example, the first input image 106 and the updated second input image 118 can be fused using image fusion technique with base-detail decomposition and flexible color and details adjustment. In examples where the first input image 106 is an RGB image and the second image is an NIR image, the RGB image can be converted into a color space where its luminance channel can be extracted, such as the L*a*b* color space. Assuming the NIR image is already a monochrome image, the NIR image can be used to compute the infrared (IR) emission strength. The strength can be derived from the deviation of the values in the NIR image from the brightness of the luminance channel of the RGB image.

In one example, the IR emission strength can be computed as follows. The image processing application 104 can calculate the difference (δ between the luminance of the RGB image and the NIR image. The image processing application 104 can further calculate the mean µ and standard deviation σ of the difference δ. The image processing application 104 can normalize the difference δ using the calculated mean µ and standard deviation σ by calculating ε = (δ - µ) / σ. In some implementations, the image processing application 104 can further normalize the ε to be between 0 and 1 by calculating φ = ε/ max(ε).

In addition to calculating the IR emission strength, the image processing application 104 can also decompose the RGB image and the NIR image into their respective base and detail parts. In some examples, guided image filter is used for the decomposition. The base of the RGB image (denoted as b_{rgb}) and the base of the NIR image (denoted as bₙᵢᵣ) can be composed together with the scaling factors of φ and α, such as by calculating b = (b_{rgb} × α + bₙᵢᵣ × φ)/(α + φ). Here, φ is the normalized ε calculated above. As an example α can be (1-φ). Alternatively, α can be a constant number, such as 1. The scaling factors φ and α control the weights applied to the base values of the RGB image with respect to the base values of the NIR image, thereby affecting the color appearance of the fused image. In this way, the weight from the NIR can be reduced for the regions with high IR deviation. Otherwise, the color will deviate more from the original RGB. Similarly, the detail of the RGB image (denoted as d_{rgb}) and the detail of the NIR image (denoted as dₙᵢᵣ) can be composed together with the scaling factors of γ and β, such as by calculating d = (d_{rgb} × β + dₙᵢᵣ × γ) / (β + γ). The scaling factors γ and β control the weights applied to the detail values of the RGB image with respect to the detail values of the NIR image, thereby affecting the edge enhancement of the fused image. The scaling factors y and β are configured to boost the details of either the RGB image or the NIR image. A higher β than γ will have more details from the RGB image than the NIR image and vice versa. For preventing see-through clothing, the edges/details on the foreground human object can be reduced from the NIR image by reducing γ in that region. So, similar to the scaling factors for the bases, β and γ can be either variable weights or constant numbers. The composed base b and detail d can be recombined to form a new luminance image. This luminance image can then be combined with the color channels of the RGB image (e.g., the a*b* channels in the above example) to generate the fused image.

It should be understood that the image fusion technique described above is for illustration purposes and should not be construed as limiting. Other image fusion techniques can also be used to fuse the first input image and the second input image.

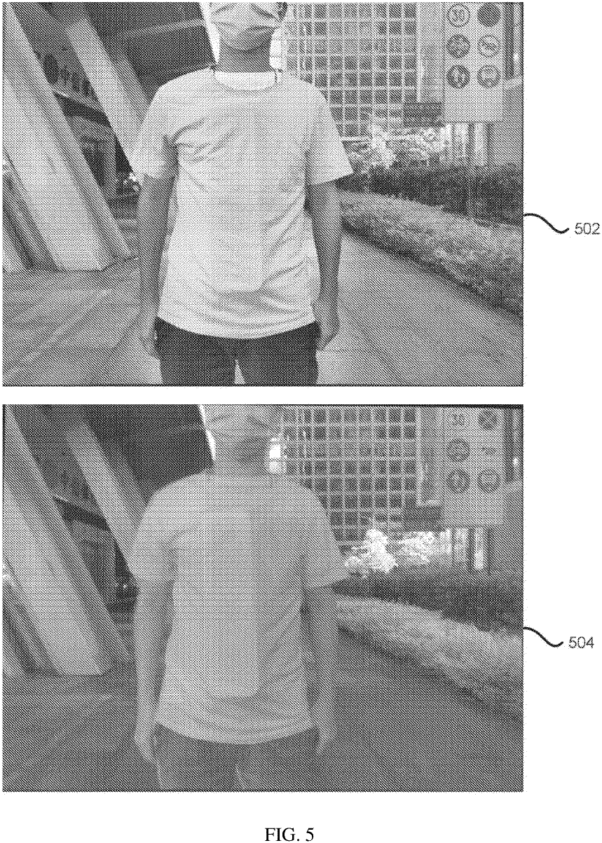

FIG. 5 depicts an example of a fused image 502 by fusing the input image 302 shown in FIG. 3 and the NIR image 402 shown in FIG. 4 according to some embodiments of the present disclosure. FIG. 5 further shows a fused image 504 by fusing the input image 302 and the NIR image 402 using a prior art image fusion method. In the fused image 504 generated by the prior art method, the ghosting artifacts appear in the foreground human object and the text of the plate under the clothes of the human object is visible. The fused image 502 generated according to the present disclosure is free of ghosting artifacts and the text of the plate is invisible.

While the examples shown in FIGS. 3-5 focus on fusing a grayscale image and an NIR image, the technologies presented herein are applicable to any type of input images. For example, the first input image 106 can be any type of color image or monochrome image. Likewise, the second input image 108 can be an NIR image discussed above, or another type of image. If the second input image 108 does not have a see-through problem, the technologies presented herein can be used to at least eliminate ghosting artifacts in the fused image.

It should be further understood that while in the above description, image fusion is performed after integrating the cropped image portion into the second input image (e.g., block 214 is performed after block 212), image fusion can be performed before the integration and the de-ghosting and see-through prevention presented herein can be performed as a post-processing. For instance, the image processing application 104 can fuse the first and second input images after they are aligned. The remaining operations of block 204 and the operations of blocks 206-210 can be performed as described above to obtain the cropped image portion from the first input image. The image processing application 104 can then integrate the cropped image portion into the fused image to generate the final fused image.

Computing System Example for Implementing De-ghosting and See-through Prevention for Image Fusion

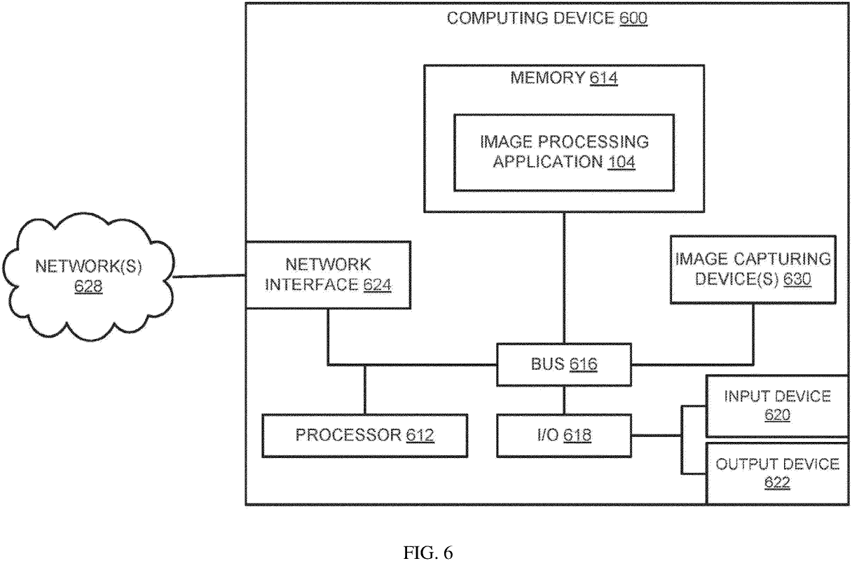

Any suitable computing system can be used for performing the operations described herein. For example, FIG. 6 depicts an example of a computing device 600 that can implement a processing device in the computing system 102 of FIG. 1. In some embodiments, the computing device 600 can include a processor 612 that is communicatively coupled to a memory 614 and that executes computer-executable program code and/or accesses information stored in the memory 614. The processor 612 may comprise a microprocessor, an application-specific integrated circuit (“ASIC”), a state machine, or other processing device. The processor 612 can include any of a number of processing devices, including one. Such a processor can include or may be in communication with a computer-readable medium storing instructions that, when executed by the processor 612, cause the processor to perform the operations described herein.

The memory 614 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 600 can also include a bus 616. The bus 616 can communicatively couple one or more components of the computing device 600. The computing device 600 can also include a number of external or internal devices such as input or output devices. For example, the computing device 600 is shown with an input/output (“I/O”) interface 618 that can receive input from one or more input devices 620 or provide output to one or more output devices 622. The one or more input devices 620 and one or more output devices 622 can be communicatively coupled to the I/O interface 618. The communicative coupling can be implemented via any suitable manner (e.g., a connection via a printed circuit board, connection via a cable, communication via wireless transmissions, etc.). Non-limiting examples of input devices 620 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 622 include an LCD screen, an external monitor, a speaker, or any other device that can be used to display or otherwise present outputs generated by a computing device.

The computing device 600 can execute program code that configures the processor 612 to perform one or more of the operations described above with respect to FIGS. 1-5. The program code can include the image processing application 104. The program code may be resident in the memory 614 or any suitable computer-readable medium and may be executed by the processor 612 or any other suitable processor.

The computing device 600 can also include at least one network interface device 624. The network interface device 624 can include any device or group of devices suitable for establishing a wired or wireless data connection to one or more data networks 628. Non-limiting examples of the network interface device 624 include an Ethernet network adapter, a modem, and/or the like. The computing device 600 can transmit messages as electronic or optical signals via the network interface device 624.

The computing device 600 can also include image capturing device(s) 630, such as a camera or other imaging device that is capable of capturing a photographic image. The image capturing device(s) 630 can be configured to capture still images and/or video. The image capturing device(s) 630 may utilize a charge coupled device (“CCD”) or a complementary metal oxide semiconductor (“CMOS”) image sensor to capture images. Settings for the image capturing device(s) 630 may be implemented as hardware or software buttons. In some examples, the computing device 600 can include a regular color camera configured for capturing RGB color images and an NIR camera configured for capturing NIR images. The regular color camera and the NIR camera can be configured so that the fields of the view of the two cameras are substantially the same. In addition, the two cameras may have a matching resolution and have a synchronous image capturing from both sensors.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied-for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A computer-implemented method, performed by one or more processing devices, comprising:
receiving a first image and a second image;
generating a foreground object mask for a foreground object in the first image;
dilating the foreground object mask to obtain a dilated mask;
integrating image content extracted from the first image according to the dilated mask with the second image to obtain an updated second image; and
fusing the first image and the updated second image to obtain a fused image.

2. The computer-implemented method of claim 1, wherein integrating image content extracted from the first image according to the dilated mask with the second image comprises:
generating a bounding box of the dilated mask;
cropping an image portion of the first image in the bounding box; and
inserting the image portion into the second image to obtain the updated second image.

3. The computer-implemented method of claim 1, wherein integrating image content extracted from the first image comprises:
replacing co-located content in the second image with the image content extracted from the first image; and
adjusting values of pixels in the replaced content in the second image.

4. The computer-implemented method of claim 3, wherein integrating image content extracted from the first image is performed via Poisson blending.

5. The computer-implemented method of claim 1, wherein the second image contains the foreground object, the computer-implemented method further comprising:
calculating a largest disparity of the foreground object between the first image and the second image, wherein a size of a structuring element for dilating the foreground object mask is determined based on the largest disparity of the foreground object between the first image and the second image.

6. The computer-implemented method of claim 1, further comprising performing image registration for the first image and the second image prior to generating the foreground object mask.

7. The computer-implemented method of claim 1, wherein the first image and the second image are both digital photographs and have an overlapping field of view of a real-world scene.

8. The computer-implemented method of claim 1, wherein the first image is one of a red-green-blue (RGB) color image or a grayscale image and the second image is a near-infrared (NIR) image.

9. A non-transitory computer-readable medium having program code that is stored thereon, the program code executable by one or more processing devices for performing operations comprising:
generating a foreground object mask for a foreground object in a first image;
dilating the foreground object mask to obtain a dilated mask;
integrating image content extracted from the first image according to the dilated mask with a second image to obtain an updated second image; and
fusing the first image and the updated second image to obtain a fused image.

10. The non-transitory computer-readable medium of claim 9, wherein integrating image content extracted from the first image according to the dilated mask with the second image comprises:
generating a bounding box of the dilated mask;
cropping an image portion of the first image in the bounding box; and
inserting the image portion into the second image to obtain the updated second image.

11. The non-transitory computer-readable medium of claim 9, wherein integrating image content extracted from the first image comprises:
replacing co-located content in the second image with the image content extracted from the first image; and
adjusting values of pixels in the replaced content in the second image.

12. The non-transitory computer-readable medium of claim 9, wherein the second image contains the foreground object, and wherein the operations further comprise:
calculating the largest disparity of the foreground object between the first image and the second image, wherein a size of a structuring element used for dilating the foreground object mask is determined based on the largest disparity of the foreground object between the first image and the second image.

13. The non-transitory computer-readable medium of claim 9, wherein the first image and the second image are both digital photographs and have an overlapping field of view of a real-world scene.

14. The non-transitory computer-readable medium of claim 9, wherein the first image is one of a red-green-blue (RGB) color image or a grayscale image and the second image is a near-infrared (NIR) image.

15. A system comprising:
a processing device; and
a non-transitory computer-readable medium communicatively coupled to the processing device, wherein the processing device is configured to execute program code stored in the non-transitory computer-readable medium and thereby perform operations comprising:
generating a foreground object mask for a foreground object in a first image;
dilating the foreground object mask to obtain a dilated mask; and
integrating image content extracted from the first image according to the dilated mask with a second image to obtain an updated second image.

16. The system of claim 15, wherein integrating image content extracted from the first image according to the dilated mask with the second image comprises:
generating a bounding box of the dilated mask;
cropping an image portion of the first image in the bounding box; and
inserting the image portion into the second image to obtain the updated second image.

17. The system of claim 15, wherein integrating image content extracted from the first image comprises:
replacing co-located content in the second image with the image content extracted from the first image; and
adjusting values of pixels in the replaced content in the second image.

18. The system of claim 15, wherein the second image contains the foreground object, and the operations further comprise:
calculating the largest disparity of the foreground object between the first image and the second image, wherein a size of a structuring element used for dilating the foreground object mask is determined based on the largest disparity of the foreground object between the first image and the second image.

19. The system of claim 15, wherein the second image is a fused image generated by fusing the first image with a third image.

20. The system of claim 15, wherein the first image is one of a red-green-blue (RGB) color image or a grayscale image and the second image is a near-infrared (NIR) image, and wherein the operations further comprise fusing the first image and the updated second image to obtain a fused image.
